(19) United States
(12) Patent Application Publication
(10) Pub. No.: US 2025/0285021 A1
(43) Pub. Date: Sep. 11, 2025

(54) POLICY LEARNING APPARATUS AND METHOD BASED ON SKILL DIFFUSION, AND OPERATION APPARATUS BASED ON DIFFUSED SKILL-BASED POLICY

(71) Applicant: RESEARCH & BUSINESS FOUNDATION SUNGKYUNKWAN UNIVERSITY, Suwon-si (KR)

(72) Inventors: Hong Uk WOO, Suwon-si (KR); Woo Kyung KIM, Suwon-si (KR); Min Jong YOO, Suwon-si (KR)

(21) Appl. No.: 19/062,383

(22) Filed: Feb. 25, 2025

(30) Foreign Application Priority Data
Mar. 5, 2024 (KR) 10-2024-0031373

(51) Int. Cl. G06N 20/00

(52) U.S. Cl. CPC G06N 20/00

(57) ABSTRACT

The present invention relates to a skill diffusion-based policy learning device and method, as well as a diffused skill-based policy-based operation device. A policy learning apparatus comprises an encoder configured to be trained to obtain a domain-invariant skill embedding based on at least one state and at least one action, and obtain a domain-variant skill embedding based on a domain parameter corresponding to the at least one state and the at least one action and the domain-invariant skill embedding and a decoder configured to be trained to obtain a skill as an output value using the domain-invariant skill embedding and the domain-variant skill embedding as inputs.

### CROSS-REFERENCE TO RELATED APPLICATION

This application claims the priority benefit of Korean Patent Application No. 10-2024-0031373 filed on Mar. 5, 2024 in the Korean Intellectual Property Office, the disclosures of which are incorporated herein by reference.

### BACKGROUND

### 1. Field

The present disclosure relates to a policy learning apparatus and method based on skill diffusion, and operation apparatus based on diffused skill-based policy.

### 2. Description of the Related Art

The skill-based reinforcement learning method is a learning method that may learn a skill based on a data set corresponding to a specific domain and more effectively perform policy adaptation on a given downstream task using the learned skill. Here, the skill refers to a basic and learned behavior provided to be performed by an agent under a specific condition or situation (i.e., a domain), or a combination of these behaviors. The domain is not directly related to the skill, but refers to Transition Dynamics (for example, the intensity of wind acting on the ball at the time of pitching, etc.) that the agent needs to consider for determination, or an additional purpose (Objective, for example, the speed of the pitched ball) that affects the learning success rate. Meanwhile, policy adaptation refers to a process in which an artificial intelligence-based agent adjusts or modifies a policy or a strategy in order to adapt to changes in an environment, a condition, a situation, or the like. The skill-based reinforcement learning enables policy adaptation to a complicated long-horizon task to be performed more quickly by utilizing a pre-trained skill for a behavior pattern of a data set.

In the related art, a hierarchical skill learning structure has been proposed for agent learning that performs a task for a long time. Such a hierarchical skill learning structure is provided to learn a skill from an offline data set corresponding to a specific domain and to perform policy adaptation for the skill based on the learned skill. However, such a hierarchical skill learning method has a problem in that the learning result is dependent on the domain of the data set used for training because the diversity of the learned skills is inevitably limited to the data set used for training. In other words, if the difference between the domain of the target task and the domain of the data set used for learning the skill is significant (i.e., if the domain is different), the agent has difficulty in selecting or determining appropriate skills for solving the corresponding target task, and as a result, it is impossible to efficiently adapt or optimize the policy for the target task.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The present invention has been made in an effort to provide a policy learning apparatus, a skill learning method, and a policy-based operation apparatus which diffuse a skill learned based on a data set of a specific domain to expand diversity of the acquired skill, and perform policy adaptation at an efficient and high level even for a domain different from a domain of a data set used for learning using the expanded diversity of the acquired skill.

To solve the aforementioned problems, a policy learning apparatus, a policy learning method, and a policy-based operation apparatus are provided.

A policy learning apparatus comprises an encoder configured to be trained to obtain a domain-invariant skill embedding based on at least one state and at least one action, and obtain a domain-variant skill embedding based on a domain parameter corresponding to the at least one state and the at least one action and the domain-invariant skill embedding and a decoder configured to be trained to obtain a skill as an output value using the domain-invariant skill embedding and the domain-variant skill embedding as inputs.

The encoder obtains the domain-invariant skill embedding by further using a domain-invariant prior generated according to a predetermined state, or obtains the domain-variant skill embedding by further using a domain-variant prior providing a prior distribution for the domain-variant skill embedding.

The decoder obtains an input value to which noise is added by adding noise to at least one action, with respect to at least one of the domain-invariant skill embedding and the domain-variant skill embedding.

The decoder obtains at least one action by repeatedly obtaining a next input a predetermined number of times and removing the noise, and obtains at least one skill through a combination of the obtaining.

The encoder is further trained through at least one of few-shot imitation learning and online reinforcement learning adaptation.

A policy learning method comprises obtaining, by an encoder, a domain-invariant skill embedding as an output by inputting at least one state and at least one action, obtaining, by the encoder, a domain-variant skill embedding as an output by inputting a domain parameter corresponding to the at least one state and the at least one action and the domain-constant skill embedding and obtaining, by a decoder, a skill as an output by inputting the domain-invariant skill embedding and the domain-variant skill embedding.

The obtaining the domain-invariant skill embedding as an output comprises obtaining the domain-invariant skill embedding by further using a domain-invariant prior generated according to a predetermined state.

Additionally, The obtaining the domain-invariant skill embedding as an output comprises obtaining the domain-variant skill embedding by further using a domain-variant prior providing a prior distribution for the domain-variant skill embedding.

The obtaining, by a decoder, a skill as an output by inputting the domain-invariant skill embedding and the domain-variant skill embedding further comprises obtaining an input value to which noise is added by adding noise to at least one action, with respect to at least one of the domain-invariant skill embedding and the domain-variant skill embedding.

The obtaining, by a decoder, a skill as an output by inputting the domain-invariant skill embedding and the domain-variant skill embedding further comprises obtaining at least one action by repeatedly obtaining a next input a predetermined number of times and removing the noise, and obtaining at least one skill through a combination of the obtaining.

A policy learning method further comprises further training the encoder through at least one of few-shot imitation learning and online reinforcement learning adaptation.

A policy-based operation apparatus comprises an encoder pre-trained to obtain a domain-invariant skill embedding based on at least one state and at least one action, and obtain a domain-variant skill embedding based on a domain parameter corresponding to the at least one state and the at least one action and the domain-invariant skill embedding and a decoder trained to obtain a skill corresponding to a downstream operation input based on the domain-invariant skill embedding and the domain-variant skill embedding.

According to the above-described policy learning apparatus, skill learning method, and policy-based operation apparatus, it is possible to expand the diversity of skills obtained from a data set of a specific domain, and to perform policy adaptation to other task(s) having a domain different from the domain distribution of the data set used for learning at a high efficiency and high level based on the expanded diversity of skills.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of a policy learning apparatus according to an embodiment.

FIG. 2 is a first block diagram illustrating a first learning process of a processor of a policy learning apparatus according to an embodiment.

FIG. 3 is a second block diagram illustrating a first learning process of a processor of a policy learning apparatus according to an embodiment.

FIG. 4 is a third block diagram illustrating a second learning process of a processor of a policy learning apparatus according to an embodiment.

FIG. 5 is a diagram for explaining the effect of skill learning according to skill diffusion according to an embodiment.

FIG. 6 is a diagram for describing an effect of skill learning according to skill diffusion according to an embodiment.

FIG. 7 is a diagram for describing an effect of skill learning according to skill diffusion in the case of online reinforcement learning adaptation.

FIG. 8 is a diagram illustrating domain-invariant skill embedding and domain-variant skill embedding according to an embodiment.

FIG. 9 is a graph diagram for explaining the effect of skill learning according to skill diffusion in the case of few-shot imitation learning.

FIG. 10 is a graph diagram for explaining the effect of skill learning according to skill diffusion in the case of online reinforcement learning adaptation.

FIG. 11 is a flowchart of a policy learning method according to an embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, as well as the methods for achieving them, will become apparent with reference to the embodiments described below in conjunction with the accompanying drawings. However, the present invention is not limited to the embodiments disclosed herein and may be implemented in various different forms. The embodiments are merely provided to ensure a complete disclosure of the present invention and to fully convey the scope of the invention to those skilled in the art. The present invention is defined solely by the scope of the claims.

The terms used in this specification will be briefly explained, followed by a detailed description of the present invention. The terms used in the present invention have been selected as commonly used general terms while considering their functions within the invention. However, these terms may vary depending on the intent of those skilled in the art, precedents, or the emergence of new technologies. In certain cases, the applicant may have arbitrarily selected specific terms, and in such cases, their meanings will be described in detail in the relevant parts of the invention. Therefore, the terms used in the present invention should not be interpreted merely based on their names but should be defined based on their meanings and the overall context of the invention. Unless otherwise explicitly stated, when a portion of the specification describes that a certain component “includes” another component, it does not exclude additional components but rather allows for the inclusion of other components. Additionally, terms such as “unit,” “module,” and “part” used in the specification refer to an entity that processes at least one function or operation and may be implemented as software, hardware components such as FPGA or ASIC, or a combination of software and hardware. However, these terms are not limited to either software or hardware. A “unit,” “module,” or “part” may be implemented on an addressable storage medium or configured to execute on one or more processors. For example, terms like “unit,” “module,” and “part” encompass software components, object-oriented software components, class components, and skill components, as well as processes, functions, attributes, procedures, subroutines, program code segments, drivers, firmware, microcode, circuits, data, databases, data structures, tables, arrays, and variables. Ordinal terms such as “first” and “second” may be used to describe various components, but such components are not limited by these terms. These terms are used only to distinguish one component from another. For example, a “first” component may be referred to as a “second” component without departing from the scope of the invention, and similarly, a “second” component may be referred to as a “first” component. The term “and/or” may be interpreted as including a combination of multiple related items or at least one of the multiple related items.

The following provides a detailed description of the embodiments of the present invention with reference to the accompanying drawings to enable those skilled in the art to readily implement the invention. In the drawings, portions unrelated to the explanation are omitted for clarity in describing the present invention.

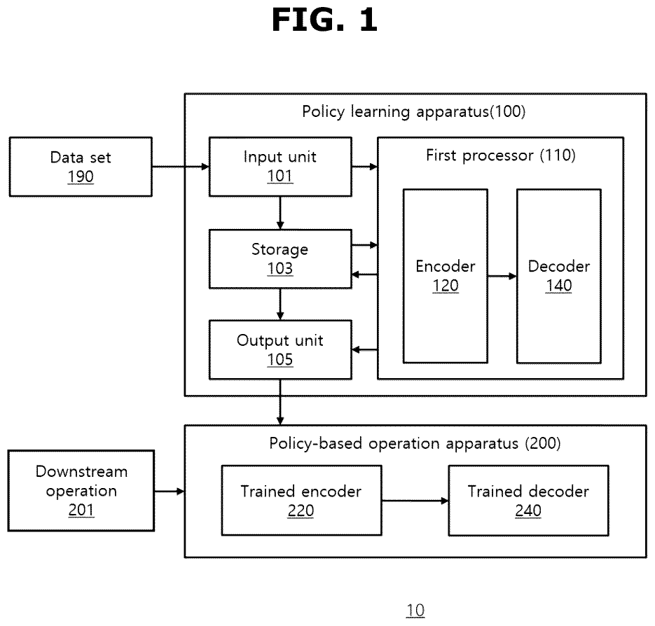

Hereinafter, an embodiment of a policy learning apparatus, a policy-based operation apparatus 200, and a policy learning system including the same will be described with reference to FIGS. 1 to 9.

FIG. 1 is a block diagram of a policy learning apparatus according to an embodiment.

Referring to FIG. 1, a policy learning system 10 according to an embodiment may include one or two or more policy learning apparatus 100 and one or two or more policy-based operation apparatus 200.

The policy learning apparatus 100 is provided to be able to perform policy adaptation by obtaining at least one data set 190, and learning a policy by learning skill(s) from the at least one data set 190. Here, the policy may be a method or strategy for determining an action that can be performed in response to a given state or environment. The policy learning means that learning of a policy is performed so that an optimal action suitable for a situation may be selected, and may be performed, for example, through a process of maximizing reward. In this case, the policy learning apparatus 100 may be trained to obtain an appropriate skill even for a domain different from the domain of the data set 190 used for training, by obtaining more diverse skill(s) than a skill derivable from the data set 190 using skill diffusion.

The policy-based operation apparatus 200 is provided to receive at least one operation, for example, a downstream operation 201, and to determine a series of operation(s), that is, a skill, effectively corresponding to the received downstream operation 201. The downstream operation 201 refers to a given problem or operation that needs to be solved. For example, the downstream operation 201 may include a series of operations in which the robot moves an object from one location to another. The policy-based operation apparatus 200 may determine and obtain at least one skill corresponding to the downstream operation 201 by using the encoder 220 and the decoder 240 trained by one or two or more policy learning apparatus 100, and may take a series of operations according to the determined skill as necessary.

According to an embodiment, one or two or more policy learning apparatus 100 and one or two or more policy-based operation apparatus 200 may be connected to each other in a wired or wireless communication network so as to communicate with each other. Accordingly, data, commands/instructions, and/or programs (which may be referred to as apps, applications, or software) may be transmitted from one side to the other side. For example, the policy learning apparatus 100 may train the encoder 120 and/or the decoder 140 to obtain a trained encoder 220 and/or a trained decoder 240. In addition, the trained encoder 220 and/or the trained decoder 240 may be transmitted to the policy-based operation apparatus 200 through a wired/wireless network in real time or non-real time, so that the policy-based operation apparatus 200 may perform a policy adaptation operation based on the trained encoder 220 and/or the trained decoder 240. In addition, the policy learning apparatus 100 and the policy-based operation apparatus 200 may not be able to communicate with each other. In this case, the encoder 120 and/or the decoder 140 trained by the policy learning apparatus 100 may be provided to the policy-based operation apparatus 200 using a data storage medium such as a memory apparatus (a USB memory, a compact disk, or the like), and may be provided to the policy-based operation apparatus 200, for example, in the form of a program code corresponding to the encoder 120 and/or the decoder 140, or in the form of an application or a program package including the same.

According to an embodiment, at least one of the policy learning apparatus 100 and the policy-based operation apparatus 200 may be implemented using one or more apparatuses specially designed to perform an operation such as learning processing or policy adaptation as described below, or may be implemented using at least one information processing apparatus alone or in combination. Here, the at least one information processing apparatus may include, for example, a hardware apparatus for a server, a desktop computer, a laptop computer, a smartphone, a tablet PC, a smart watch, a portable game machine, a Head Mounted Display (HMD) apparatus, a navigation apparatus, an manned or unmanned moving object (e.g., a vehicle, a mobile robot, a wireless model vehicle, a robot cleaner, etc.), an manned or unmanned flying object (e.g., an aircraft, a helicopter, a drone, a model airplane, a model helicopter, etc.), an industrial robot, a robot arm, a military robot, a machine tool, a traffic controller, a medical apparatus, a home appliance, a sound reproducing apparatus (an artificial intelligence speaker, etc.), a digital television, a set top box, a digital media player apparatus, a media streaming apparatus, an image capturing apparatus, or the like. More specifically, for example, the policy learning apparatus 100 may be a hardware apparatus for a server built for learning, and the policy-based operation apparatus 200 may be a robot arm provided to perform a series of operations in a factory or the like, a robot system including the same, or an information processing apparatus connected thereto. However, the policy learning apparatus 100 or the policy-based operation apparatus 200 is not limited to the above description. A designer or a user may employ various operation processing and control apparatuses as at least one of the policy learning apparatus 100 and the policy-based operation apparatus 200 according to a situation or a condition.

According to an embodiment, the policy learning apparatus 100 may include an input unit 101, a storage 103, an output unit 105, and a processor 110. Here, at least two of the input unit 101, the storage 103, the output unit 105, and the processor 110 may be connected to transmit data or commands/instructions to one or both of them. At least one of the input unit 101, the storage 103, and the output unit 105 may be omitted according to an embodiment.

The input unit 101 may receive, from the outside, at least one piece of data, at least one program, or at least one command/instruction, which is required for the operation of the policy learning apparatus 100. For example, the input unit 101 may receive at least one data set 190 used to perform learning of a skill, and provide it to the storage 103 or the first processor 110. The input unit 101 may be implemented using one or more apparatus devised to input at least one data or program, and may include, for example, a keyboard, a mouse, a tablet, a touch screen, a track pad, a scanner apparatus, an image photographing module, a microphone, a data input/output terminal (e.g., a USB terminal), and/or a communication module.

The storage 103 may temporarily or non-temporarily store data (e.g., all or part of the data set 190, etc.) necessary for the operation of the policy learning apparatus 100, at least one program, or instructions/instructions, etc. For example, the storage 103 may receive data received by the input unit 101, receive data generated in the processing process of the processor 110 (e.g., domain-invariant skill embedding or domain-variant skill embedding obtained by the encoder 120), or receive and store a processing result of the processor 110 (e.g., the trained decoder 140). In addition, the storage 103 may provide necessary data or programs to the processor 110 according to a call of the processor 110. The storage 103 may be implemented using a predetermined memory apparatus provided to temporarily or non-temporarily store at least one piece of data and/or at least one program, and according to an embodiment, may include at least one of a register, a cache memory, a main memory apparatus, and an auxiliary memory apparatus.

The output unit 105 may output a processing result of the processor 110 (e.g., data stored in the trained encoder 120, the trained decoder 140, or the storage 103) to the outside. For example, the output unit 105 may transmit the learning result to another apparatus communicatively connected to the policy learning apparatus 100, for example, the policy-based operation apparatus 200, so that the policy-based operation apparatus 200 may perform policy adaptation through various skills using the trained encoder 120 and decoder 140. According to an embodiment, the output unit 105 may be implemented using an image output terminal, a display, a printer apparatus, a speaker apparatus, a data input/output terminal, and/or a communication module (e.g., a LAN card, a short-range communication module, or a mobile communication module), but is not limited thereto.

In an embodiment, the processor 110 may perform computation or control processing for skill learning based on skill learning. In addition, as necessary, the processor 110 may control the overall operation of the policy learning apparatus 100 and/or control operations related to graphics processing. The processor 110 may be implemented by using at least one processing apparatus provided to perform calculation or control processing related to learning alone or in combination. Here, the at least one processing apparatus may include, for example, a Central Processing Unit (CPU), a Graphic Processing Unit (GPU), a Micro Controller Unit (MCU), an Application Processor (AP), an Electronic Controlling Unit (ECU), or a Micro Processor (Micom), but is not limited thereto. These processing apparatus may be implemented by using one or two or more semiconductor chips, circuits, or related components alone or in combination.

According to an embodiment, the processor 100 may include an encoder 120 having an embedding for a skill (i.e., skill embedding) as an output value, and a decoder 140 directly or indirectly connected to the encoder 120. The encoder 120 may include a hierarchical domain encoder. The decoder 140 may include a guided diffusion-based decoder, and is provided to perform learning by using the skill embedding obtained by the encoder 120 as an input value and using the skill as an output value. The encoder 120 and the decoder 140 may be logically separated from each other or may be physically separated from each other, according to embodiments. That is, the encoder 120 and the decoder 140 may be implemented using only one physical processing apparatus or may be implemented using separate physical processing apparatus, depending on the situation. More specifically, for example, the encoder 120 and the decoder 140 may be implemented using only one graphic processing unit, or the encoder 120 may be implemented using a central processing unit, and the decoder 140 may be implemented using a graphic processing unit physically separated from the central processing unit.

In the case of a downstream operation 201 having a domain different from the domain premised in learning, it is not easy to solve the operation 201 simply by imitating the existing data set 190. Typically, the operation 201 is shown in the form of a Markov decision process (MDP) (M) combined with the domain (Ω), and such a target conditional Markov determination process (M) may be represented using the general (S, A, P, r, G, γ, ρ0). Here, S denotes a state space (s∈S), A denotes an action space (a∈A), G denotes a target space, and P denotes a transition probability (P: S×A×Ω→[0, 1]). In addition, r means a compensation function (r: S×A×G×Ω→R), γ means a discount factor (γ∈[0, 1]), and ρ0 means an initial state distribution (ρ0: S→[0, 1]). A difference between the above-described domains may affect the transition probability P or the compensation function r, even though the difference does not affect the target space G in the Markov decision process. In consideration of this, the processor 100 trains the encoder 120 and the decoder 140, so that the policy determination apparatus 200 implemented to include the trained encoder 220 and the trained decoder 240 may perform adaptation to a policy (e.g., a high level policy π_θ(z|s_t), where z is a domain skill embedding to be described later, and s_t is at least one state) even under different domains. According to an embodiment, the processor 100 may perform training of the encoder 120 and the decoder 140 by allowing the sum of the accumulated counts of the rewards in the downstream operation 201 of the different domains to be maximized with respect to the policy π_θ(z|s_t) of the high level, as shown in Equation 1 below.

$${π}^{*} = {arg min}_{θ} 𝔼 [ {\sum }_{t = 0}^{T - 1} {γ}^{t} r ( {s}_{t} , ϵ ( a \vert {π}_{θ} ( {s}_{t} ) ) ) ] \qquad [ Equation 1 ]$$

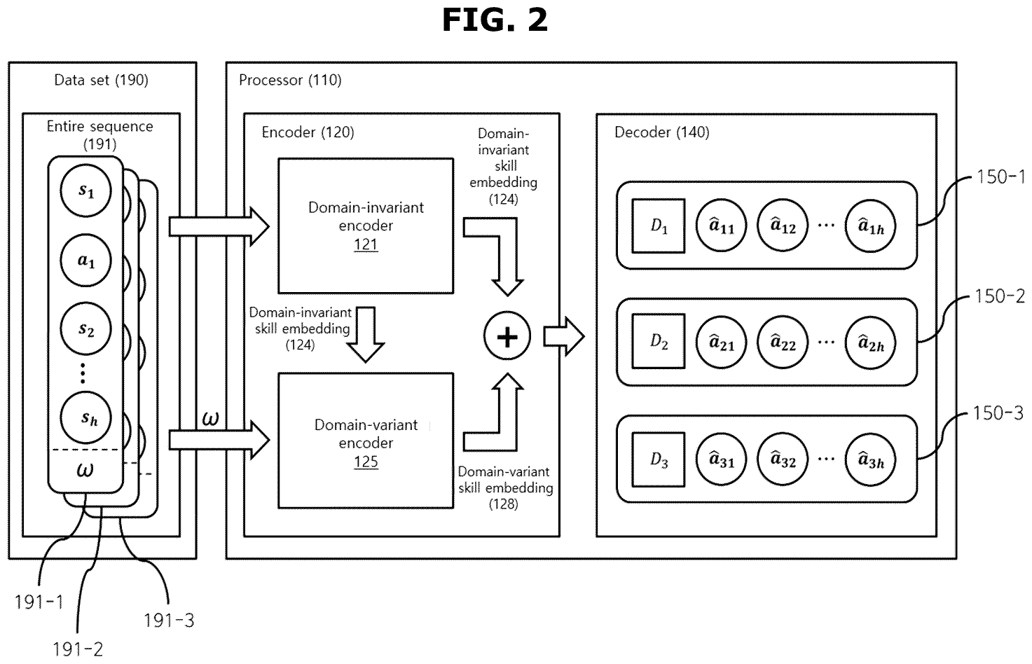

In Equation 1, T denotes a maximum length of a series of entire sequences (191 of FIG. 2).

According to an embodiment, the encoder 120 and the decoder 140 may be trained through two phases. The two processes may include a process of training the encoder 120 and the decoder 140 based on the given at least one data set 190, and a process of performing fine-tuning (fine learning) on the encoder 120 so that the decoder 140 may obtain/determine more appropriate skill(s) for the given operation 201. Fine tuning for the encoder 120 may allow the policy-based operation apparatus 200 to select a more appropriate skill even when Expert Trajectory for work is small or insufficient. The data set 190-based training for the encoder 120 and the decoder 140 and the fine tuning for the encoder 120 may be performed sequentially or simultaneously. For example, training based on the data set 190 for the encoder 120 and the decoder 140 may be performed prior to fine tuning for the encoder 120. Depending on the situation, the opposite is also possible. In addition, according to an embodiment, the training based on the data set 190 for the encoder 120 and the decoder 140 may be performed on an offline basis, and fine tuning for the encoder 120 may be performed on an online basis, or vice versa. In addition, both may be performed online or offline depending on the situation.

Hereinafter, a detailed configuration of the encoder 120 and the decoder 140 and an embodiment of a method of learning the same described above will be described in more detail with reference to FIGS. 2 to 4.

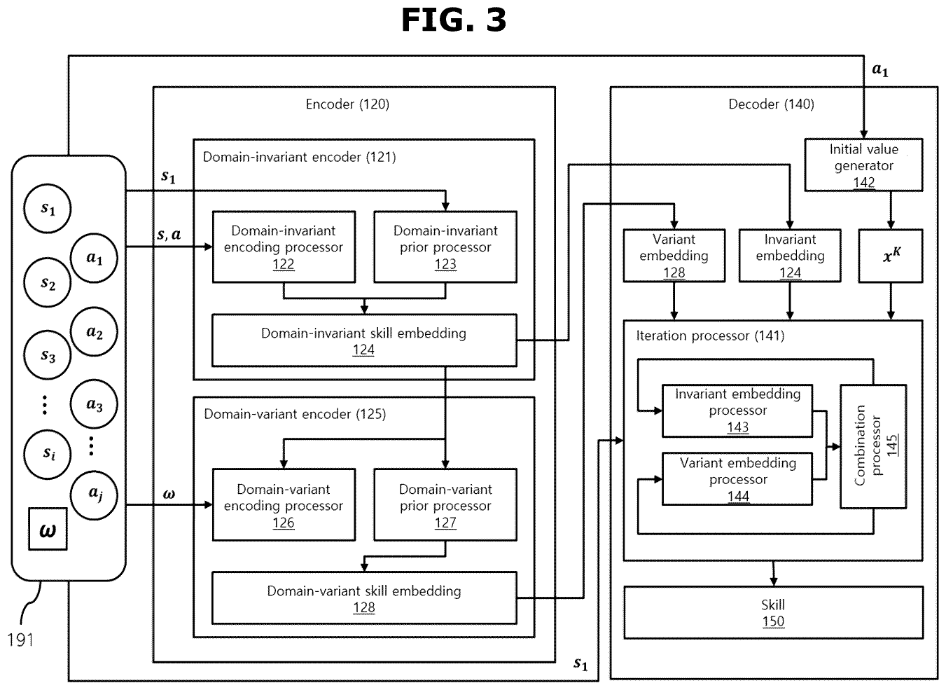

FIGS. 2 and 3 are first and second block diagrams illustrating a first learning process of a processor of a policy learning apparatus according to an embodiment.

Referring to FIGS. 2 and 3, the encoder 120 may be provided to obtain at least one data set 190 from the input unit 101 or the storage 103, obtain skill embeddings 124 and 128 using the at least one data set 190, and transmit the obtained skill embeddings 124 and 128 to the decoder 140.

According to an embodiment, the data set 190 may include at least one entire sequence 191 (191-1, 191-2, and 191-3). Each entire sequence 191 (191-1, 191-2, 191-3) may include at least one state(s) (s1, s2, s3, . . . ), include at least one action(s) (a1, . . . ), or both. The at least one state(s) (s1, s2, s3, . . . ) may include a goal, a situation, a condition, or the like related to a task. The task may refer to a part of the entire task, for example, a unit task that may configure all or part of the task according to a combination. The at least one action(s) (a1, . . . ) may include detailed and individual operations or processing that must be performed for processing of the task.

Within the entire sequence 191, the state(s) (s1, s2, s3, . . . ), the behavior(s) (a1, . . . ), or both may be arranged in a predetermined order. For example, as illustrated in FIG. 3, a plurality of continuous states (s1, s2, s3, . . . , s_i, . . . , i is a natural number of 1 or more) and a plurality of continuous actions (a1, a2, a3, . . . , a_j, . . . , j is a natural number of 1 or more) may be included in the entire sequence 191, and the plurality of states (s1, s2, s3, . . . ) and the plurality of actions a1, . . . may be sequentially arranged to form a state sequence and an action sequence. In other words, the entire sequence (191: 191-1, 191-2, 191-3) may be provided to include at least one of a state sequence and an action sequence. In this case, the number (i) of the plurality of states (s1, s2, s3, . . . , s_i, . . . ) and the number (j) of the plurality of action(s) (a1, a2, a3, . . . , a_j, . . . ) in the entire sequence 191 may be the same (i=j) or different (i≠j). Depending on the situation, the number i of the plurality of state(s) (s1, s2, s3, . . . , s_i, . . . ) may be greater or less than the number of the plurality of action(s) (a1, a2, a3, . . . , a_j, . . . ).

In the data set 190, the states (s1, s2, s3, . . . ) and the behavior s (a1, . . . ) may be mixed with each other and sequentially arranged. For example, one or more action(s) (a1, . . . ) may be placed between at least two state(s) (s1, s2, s3, . . . ). More specifically, for example, as shown in FIG. 2, any one entire sequence 191-1 may include a first state s1, a second state s2, a first action a1, and the like, and the states s1 and s2 and the action a1 may be arranged in the order of the first state s1, the first action a1, and the second state s2. When the policy-based operation apparatus 200 operates according to the corresponding entire sequence 191-1, the policy-based operation apparatus 200 operates as the first action a1 in response to the occurrence of the first state s1. The second state s2 occurs subsequently.

Also, the entire sequence 191 may further include a domain parameter w. The domain parameter w may be included in the data set 190 according to an embodiment, and may be included in each of the entire sequences 191 (191-1, 191-2, and 191-3) in the form of metadata such as, for example, an annotation. The domain parameters w of each entire sequence 191 (191-1, 191-2, 191-3) may all be the same, may be partially the same, or may all be different. The domain parameter w may be arbitrarily determined by a person who prepares the data set 190. In addition, the domain parameter w may be defined according to the state(s) (s1, s2, s3, . . . , s_i, . . . ), and/or the plurality of action(s) (a1, a2, a3, . . . , a_j, . . . ) in each overall sequence 191.

The encoder 120 according to an embodiment may include a domain-invariant encoder 121 and a domain-modifying encoder 125. Accordingly, learning may be performed in two different embedding spaces (i.e., a domain-invariant skill embedding space Zρ and a domain-variant skill embedding space Zρ).

In the first learning process, the domain-invariant encoder 121 receives at least one state(s) (s1, s2, s3, . . . ) and/or at least one action(s) (a1, . . . ) and based thereon causes the domain-invariant skill embedding 124 to be output. The domain-invariant skill embedding 124 may be intended to reflect elements necessary to reconstruct the basic sequence of actions related to achieving a goal, i.e., skills 150-1, 150-2, and 150-3. The domain-invariant skill embedding 124 may include a skill embedding corresponding to a data set 190 (e.g., the entire sequence 191) used for learning and training while the domain is maintained.

In the first learning process, the domain-variant encoder 125 may obtain the domain-variant skill embedding 128 for performing policy adaptation in different domains. The domain-variant skill embedding 128 is a skill embedding provided for processing of domain-variant (variation). In more detail, the domain-variant encoder 125 may receive the domain-invariant skill embedding 124 from the domain-invariant encoder 121, may receive the domain parameter w corresponding to the corresponding data set 190 from the data set 190 (e.g., the entire sequence 191), and may obtain the corresponding domain-variant skill embedding 128 as an output value by using the received domain-invariant skill embedding 124 and the received domain parameter ω as input values.

The obtained domain-invariant skill embedding 124 and domain-variant skill embedding 128 may be passed to the decoder 140. In this case, it is also possible for the domain-invariant skill embedding 124 and the domain-variant skill embedding 128 to be combined and then passed to the decoder 140.

In the first learning process, the decoder 140 is trained to obtain one or more skills, for example, a first skill 150-1, a second skill 150-2, and/or a third skill 150-3, as an output value by using at least one of the domain-invariant skill embedding 124 and the domain-variant skill embedding 128 as an input value. In this case, the decoder 140 may be configured to obtain at least one skill(s) that can be consistently applied to an operation regardless of a change in the domain based on the domain-invariant skill embedding 124, and obtain at least one skill(s) for coping with a difference in the domain based on the domain-variant skill embedding 128. According to an embodiment, each acquired skill 150-1, 150-2, or 150-3 may be provided by combining at least one action(s) (\hat{ }a_11, \hat{ }a_12, . . . , \hat{ }a_1h, \hat{ }a_21, \hat{ }a_22, . . . , \hat{ }a_2h, or \hat{ }a_31, a_32, . . . , \hat{ }a_3h) in whole or in part according to at least one domain D1, D2, or D3. In other words, the first skill 150-1 may be generated by including a predetermined number of behavior(s) (\hat{ }a_11, \hat{ }a_12, . . . , \hat{ }a_1h) corresponding to the first domain D1, the second skill 150-2 may be generated by including a predetermined number of behavior(s) (\hat{ }a_21, \hat{ }a_22, . . . , \hat{ }a_2h) corresponding to the second domain D2, and the third skill 150-3 may be generated by including a predetermined number of behavior(s) (\hat{ }a_31, \hat{ }a_32, . . . , \hat{ }a_3h) corresponding to the third domain D3. Depending on the situation, at least one of the first skill 150-1, the second skill 150-2, and the third skill 150-3 may include one or more behaviors that are the same as the behaviors of the other skills 150-1, 150-2, and 150-3. Each of the skills 150-1, 150-2, and 150-3 may be provided in the form of a sequence consisting of successive combinations of at least one or more action(s) (\hat{ }a_11, \hat{ }a_12, . . . , \hat{ }a_1h, \hat{ }a_21, \hat{ }a_22, . . . , \hat{ }a_2h, or \hat{ }a_31, \hat{ }a_32, . . . , \hat{ }a_3h). That is, at least one action(s) (\hat{ }a_11, \hat{ }a_12, . . . \hat{ }a_1h, \hat{ }a_21, \hat{ }a_22, . . . \hat{ }a_2h, \hat{ }a_31, \hat{ }a_32, . . . \hat{ }a_3h) may be continuously arranged according to the order to be performed within the corresponding skill 150-1, 150-2, 150-2. As the decoder 140 outputs the skills 150-1, 150-2, and 150-3 corresponding to the predetermined domains D1, D2, and D2, the execution order of at least one action(s) (\hat{ }a_11, \hat{ }a_12, . . . , \hat{ }a_1h, \hat{ }a_21, \hat{ }a_22, . . . , \hat{ }a_2h, or \hat{ }a_31, \hat{ }a_32, . . . , \hat{ }a_3h) to be performed under the corresponding domains D1, D2, and D2 and the execution order of the at least one action(s) (\hat{ }a_11, \hat{ }a_12, . . . \hat{ }a_1h, \hat{ }a_21, . . . , \hat{ }a_22, or \hat{ }a_2h, \hat{ }a_31, \hat{ }a_32 a_3h) may be determined.

Hereinafter, the first learning process of the encoder 120 and the decoder 140 described above will be described in more detail with reference to FIG. 3.

As shown in FIG. 3, the domain-invariant encoder 121 of the encoder 120 may include a domain-invariant encoding processor 122 and a domain-invariant prior processor 123, may receive data s, s1, and a to be processed from the entire sequence 191, and may obtain a domain-invariant skill embedding 124 corresponding to the data s, s1, and a as an output using the domain-invariant encoding processor 122 and the domain-invariant prior processor 123.

More specifically, when the entire sequence 191 includes a plurality of state(s) (s1, s2, s3, . . . , s_i), a plurality of action(s) (a1, a2, a3, . . . , a_j), and a domain parameter ω, the domain-invariant encoding processor 122 may receive all or some of the plurality of state(s) (s1, s2, s3, . . . , s_i, . . . ). In addition, all or some of the plurality of actions (a1, a2, a3, . . . , a_j, . . . ) may be further transferred to the domain-invariant encoding processor 122. Delivery of the action(s) (a1, a2, a3, . . . , a_j, . . . ) and delivery of the state(s) (s1, s2, s3, . . . , s_i, . . . ) may be performed together or independently. The domain-invariant prior processor 123 may receive at least one of the plurality of states (s1, s2, s3, . . . , s_i, . . . ), for example, the first state s1.

The domain-invariant encoding processor 122 may obtain a predetermined number (e.g., h) of state(s) (i.e., state sequences s={s_t, . . . , s_t+h}) and a predetermined number (e.g., h) of action(s) (i.e., action sequences a={a_t, . . . , a_t+h}) equal to the number of state(s)), and may generate a domain-invariant skill embedding 124 by inputting them. This may be expressed as Equation 2 below.

$${z}_{ρ} \sim {q}_{ρ} ( s , a ) \qquad [ Equation 2 ]$$

In Equation 2, z_ρ (zρ∈Zρ) represents the domain-invariant skill embedding 124, where s is the state sequence (s={st, . . . , st+h}) and a is the action sequence (a={at, . . . , at+h}).

On the other hand, since the domain-invariant encoding processor 122 performs learning using the state sequence s and the action sequence a as inputs, it is impossible to generate the embedding 124 for the skill only with the given current state s_t. The domain-invariant prior processor 123 may additionally train a domain-invariant prior to obtain the domain-invariant skill embedding 124. The domain-invariant prior is information obtained in advance with respect to an environment, a state, or the like, and may be determined according to a current state s_t, for example, a first state s1. The domain-invariant prior allows for a more appropriate domain-invariant skill embedding 124 to be created. The domain-invariant prior may be expressed by Equation 3 below.

$${z}_{ρ} \sim {p}_{ρ} ( {s}_{t} ) \qquad [ Equation 3 ]$$

The domain-variant encoder 125 of the encoder 120 may include a domain-variant encoding processor 126 and a domain-variant prior processor 127, may receive the domain-invariant skill embedding 124 and the domain parameter ω, and may acquire, as an output, the domain-variant skill embedding 128 corresponding to these 124 and ω by using the domain-variant encoding processor 126 and the domain-variant prior processor 127.

The domain-variant encoding processor 126 may receive the domain-invariant skill embedding 124 and the domain parameter ω, and may generate the domain-variant skill embedding 128 by using them as input. In this case, the processing of the domain-variant encoding processor 126 may be expressed as Equation 4 below.

$${z}_{σ} \sim {q}_{σ} ( {z}_{ρ} , ω ) \qquad [ Equation 4 ]$$

In Equation 4, zσ (zσ∈Zσ) represents the domain-variant skill embedding 128, and z_ρ represents the domain-invariant skill embedding 124.

As in the case of the domain-invariant encoding processor 122 described above, the domain-variant prior processor 127 may acquire the domain-variant prior in order to generate the domain-variant skill embedding 128. The domain-variant prior is provided to be able to provide a prior distribution for the domain-variant skill embedding 128. For example, the domain-variant prior may be represented by Equation 5 below.

$${z}_{σ} \sim {p}_{σ} ( {z}_{ρ} ) \qquad [ Equation 5 ]$$

When the domain-variant prior is given as in Equation 5, since the domain-variant prior is modeled by using only the domain-invariant skill embedding 124 as a condition, various parameters may be acquired over several domains.

The domain-invariant prior and the domain-variant prior may be finely adjusted according to a situation, and accordingly, a skill embedding suitable for a domain of a corresponding environment may be generated for each environment to be adapted.

A predetermined loss function may be used to perform learning of the domain-invariant encoding processor 122 and the domain-variant encoding processor 126. This loss function allows domain-invariant skill encoding 124 and domain-variant skill encoding 128 to be separated from the skill. The loss function may be given, for example, as shown in Equation 6 below.

$${ℒ}_{aspect} = {𝔼}_{s , a} \sim {𝒟}_{s} [ log \frac{q ( {z}_{σ} \vert {z}_{ρ} , s , a )}{{q}_{σ} ( {z}_{σ} \vert {z}_{ρ} , ω )} ] \qquad [ Equation 6 ]$$

The loss function of Equation 6 allows the domain-variant encoding processor 126 to build a distinct embedding space Zσ by effectively obtaining domain-variant features under the conditions of the domain-invariant skill embedding 124.

The domain-invariant prior processor 123 and the domain-variant prior processor 127 may be trained together with the encoder 120 by minimizing a Kullback-Leibler divergence (KLD) between the encoders 121 and 125, in an embodiment. In this case, the domain-invariant prior processor 123 and the domain-variant prior processor 127 may be optimized using a loss function as shown in Equation 7 below.

$${ℒ}_{prior} = {E}_{( s , a )} \sim {D}_{s} [ {D}_{KL} ( {p}_{ρ} ( {z}_{ρ} \vert {s}_{t} ) ‖ {q}_{ρ} ( {z}_{ρ} \vert s , a ) ) + {D}_{KL} ( {p}_{σ} ( {z}_{σ} \vert {z}_{ρ} ) ‖ q ( {z}_{σ} \vert {z}_{ρ} , ω ) ) ] \qquad [ Equation 7 ]$$

The decoder 140 is provided to receive the domain-invariant skill embedding 124 and the domain-variant skill embedding 128 from the encoder 120 and decode and acquire the skill based on the diffusion model.

According to an embodiment, the decoder 140 may be provided to perform skill decoding using a noise removal method. The noise removal method is a method of generating an actual output value by repeatedly inferring the same diffusion model for several times and performing noise removal for several times. Here, the noise removal method may use, for example, a Denoising Diffusion Probabilistic Model (DDPM). In this case, as shown in FIG. 3, the decoder 140 may include a iteration processor 141 configured to perform a iteration process more than a predetermined number of times using the domain-invariant skill embedding 124 and the domain-variant skill embedding 128, and an initial value generator 142 configured to obtain an initial input value (x\hat{ }K) for the iteration processor 141. The iteration processor 141 is provided to obtain a desired output value (i.e., action a_t) from an arbitrary random vector using a noise removal method. Specifically, for example, the iteration processor 141 reconfigures each successive action (a_2 a_3, . . . ) at each iteration, and inputs (x\hat{ }(K−1), x\hat{ }(K−2), . . . ) to which at least one noise (ηN) corresponding to each action (a_2 a_3, . . . ) is added. Here, x0(=at) is sequentially obtained. That is, the iteration processor 141 may obtain the next input value x\hat{ }(k−1) using the input value x\hat{ }k. In this case, newly obtained noise (ηs) are added to the input (x\hat{ }(K−1), x\hat{ }(K−2), . . . . Here, x0(=at) may be more removed of noise η than in the previous step. In some example embodiments, the noise η may include Gaussian noise η to N(0, I). The above-described iteration may be repeated a predetermined number of times, for example, K times, and in this process, n the noise is gradually removed. Meanwhile, the initial input value x\hat{ }K to which the noise η is added may be generated and transferred by the initial value generator 142. In this case, the initial value generator 142 may be configured to receive at least one action, for example, the first action a1, add noise η to the first action a1 to obtain an initial input value x\hat{ }K, and transmit the initial input value x\hat{ }K to the iteration processor 141.

The k-th input x_k to which the above-described noise is added may be expressed, for example, by Equation 8 below

$${x}^{k} = \sqrt{{\overline{α}}^{k}} {a}_{t} + \sqrt{1 - {\overline{α}}^{k}} η \qquad [ Equation 8 ]$$

In Equation 8, ⁻α\hat{ }k is a variance schedule and may be used to adjust the degree of uncertainty of the model. When the noise-added input x_K is obtained, the iteration processor 141 is trained to predict n the noise x_K. In this case, the loss function may be given as in Equation 9 below.

$${ℒ}_{rec} = {𝔼}_{k \sim [ 1 , K ] , η \sim 𝒩 ( 0 , I )} [ {\vert \vert ϵ ( {x}^{k} , k , {s}_{t} , {z}_{σ} , {z}_{ρ} ) - η \vert \vert}_{2}^{2} ] \qquad [ Equation 9 ]$$

Here, ϵ corresponds to the decoder 140.

According to an embodiment, the iteration processor 141 may include an invariant embedding processor 143, a variant embedding processor 144, and a combination processor 145.

According to an embodiment, the invariant embedding processor 143 may receive the domain-invariant skill embedding 124 and generate at least one skill that can be applied to the task regardless of the change in the domain (ϵ_ρk, k, s+t, z_ρ)), and the variant embedding processor 144 may receive the domain-variant skill embedding 128 and generate at least one skill that can respond to the change in the domain (ϵ_σ(x\hat{ }k, k, s_t, z_σ). In this case, the invariant embedding processor 143 may perform a learning process by performing the same or partially modified operation as described in the iteration processor 141 described above with respect to the domain-invariant skill embedding 124, and the variant embedding processor 144 may perform the same operation as described in the iteration processor 141 described above with respect to the domain-variant skill embedding 128.

The combination processor 145 may combine output results of the invariant embedding processor 143 and the variant embedding processor 144. In this case, the combination processor 145 may be expressed by Equation 10 below.

$$ϵ ( {x}^{k} , k , {s}_{t} , {z}_{ρ} , {z}_{σ} ) := ( 1 - δ ) {ϵ}_{ρ} ( {x}^{k} , k , {s}_{t} , {z}_{σ} ) + {δϵ}_{σ} ( {x}^{k} , k , {s}_{t} , {z}_{ρ} ) \qquad [ Equation 10 ]$$

Here, a left item on the right side of Equation 10 corresponds to the variant embedding processor 144, and a right item on the right side corresponds to the invariant embedding processor 143. In addition, δ is a guidance weight provided to determine the degree of adjustment using the result of the variant embedding processor 144, and may be given as a value greater than 0 according to an embodiment. This enables the variant embedding processor 144 to generate a guide that includes domain-variant features, while enabling the invariant embedding processor 143 to reconstruct behavior(s) that are consistently used for a designated task regardless of domain features.

As described above, the skill decoder 140 (ϵ(x\hat{ }k, k, s_t, z_ρ, z_σ)) may receive the input (x\hat{ }k) to which the k-th noise is added, the noise removal step (k), the current state (s_t), the domain-invariant skill embedding (z_ρ), and the domain-variant skill embedding (z_σ) as inputs and output noise, and when the above-described iterative process is performed for the length of the skill 150, at least one action for the domain-invariant skill embedding 124 may be obtained (obtained by the invariant embedding processor 143), and at least one action for the domain-variant skill embedding 148 may be obtained (obtained by the variant embedding processor 144). The at least one action for the domain-invariant skill embedding 124 and the at least one action for the domain-variant skill embedding 148 thus obtained may be combined to form an action sequence, such that the action sequence is determined to be skill 150.

In order to optimize the learning performance of the encoder 120 and the decoder 140 described above, an evidence lower bound (ELBO) may be used. In this case, the loss function based on the evidence lower limit may be expressed as Equation 11 below.

$${ℒ}_{HVAE} = {𝔼}_{s , a} \sim {𝒟}_{s} [ - {\prod }_{t = 0}^{h} log ϵ ( {a}_{t} \vert {s}_{t} , {z}_{ρ} , {z}_{σ} ) + {β}_{ρ} {D}_{KL} ( p ( {z}_{ρ} ) ‖ {q}_{ρ} ( {z}_{ρ} \vert s , a ) ) + {β}_{σ} {D}_{KL} ( p ( {z}_{σ} \vert {z}_{ρ} ) ‖ q ( {z}_{σ} \vert {z}_{ρ} , s , a ) ) ] \qquad [ Equation 11 ]$$

In Equation 11, βρ and βσ are regularized hyper parameters, and p(zσ) and p(zρ|zσ) may be set as a prior and a unit Gaussian. When Equation 6 described above is applied to Equation 11, a final loss function for the encoder 120 and the decoder 150 as shown in Equation 12 below is obtained.

$${ℒ}_{DHVAE} = {𝔼}_{s , a} \sim {𝒟}_{s} [ - {\prod }_{t = 0}^{h} log ϵ ( {a}_{t} \vert {s}_{t} , {z}_{ρ} , {z}_{σ} ) + {β}_{ρ} {D}_{KL} ( p ( {z}_{ρ} ) ‖ {q}_{ρ} ( {z}_{ρ} \vert s , a ) ) + {β}_{σ} {D}_{KL} ( p ( {z}_{σ} \vert {z}_{ρ} ) ‖ q ( {z}_{σ} \vert {z}_{ρ} , ω ) ) ] \qquad [ Equation 12 ]$$

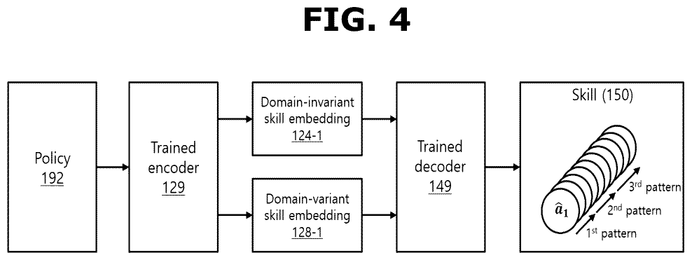

FIG. 4 is a third block diagram illustrating a second learning process of a processor of a policy learning apparatus according to an embodiment.

According to an embodiment, the encoder 129 and the decoder 149 trained through the above-described first learning process may be further trained by a second learning process. This allows learning of more efficient downstream operations to be performed. According to an embodiment, as shown in FIG. 4, the second learning process may be performed by generating skill embeddings 124-1 and 128-1 obtained by the encoder 120 as output values, instead of directly generating an action to be executed using a predetermined policy 192 (e.g., a high level policy). Here, the encoder 120 may include, for example, a trained encoder 129, but may include an encoder 120 that has not yet been trained or has been trained according to an embodiment. The policy 192 is designed to coordinate with the encoders 120, 129 such that the encoders 120, 129 can output a domain-invariant skill embedding 124-1 and a domain-variant skill embedding 128-1. In this case, the policy to be provided to the encoders 120 and 129 may be expressed by, for example, Equation 13 below.

$${π}_{θ} ( {ρ}_{} , {σ}_{} \vert {s}_{t} ) = [ {π}_{θ} ( {ρ}_{} \vert {s}_{t} ) , {π}_{θ} ( {σ}_{} \vert {ρ}_{} ) ] \qquad [ Equation 13 ]$$

Sequentially, the skill embeddings output from the encoders 120, 129 corresponding to the policy 192, e.g., the domain-invariant skill embedding 124-1 and the domain-variant skill embedding 128-1, are input to the decoder 140. Here, the decoder 140 may include a trained decoder 149, or may include a decoder 140 that is not trained or is in a process of being trained, as necessary. As described above, the decoders 140 and 149 add noise (e.g., Gaussian noise, η to N(0, I)) to an action to obtain an input value x\hat{ }K, and repeatedly perform denoising to generate at least one action(s) (\hat{ }a1, . . . ). The at least one action(s) (a\hat{ }1, . . . ) may be sequentially combined to form a sequence, thereby generating at least one skill 150. The operation of the decoder 140 may be expressed by Equation 14 below.

$${x}^{k - 1} = \frac{1}{\sqrt{{α}^{k}}} ( {x}^{k} - \frac{1 - {α}^{k}}{\sqrt{1 - \overline{{α}^{k}}}} ϵ ( {x}^{k} , k , {s}_{t} , {z}_{ρ} , {z}_{σ} ) ) + {σ}^{k} η \qquad [ Equation 14 ]$$

In Equation 14, ⁻α\hat{ }k and σ\hat{ }k are parameters for a dispersion schedule. Here, σ\hat{ }k may be set to 0.

The second learning process may be performed through at least one of few-shot imitation learning and online reinforcement learning adaptation. In the case of the few-shot imitation learning, the policy 192 is initialized through the learned domain-invariant prior and domain-variant prior, and detailed adjustment of the policy 192 is performed using the decoders 140 and 149 and the loss function of Equation 9. In the case of online reinforcement learning adaptation, a Soft-Actor-Critic (SAC) algorithm may be used. This performs guidance of the policy 192 through the learned prior. In the case of both few-shot imitation learning and online reinforcement learning adaptation, the decoders 140, 149 are not further trained or updated, and only fine-tuning of the policy 192 is performed.

By the above-described process, a trained encoder 220 and a trained decoder 240 as shown in FIG. 1 are obtained. The trained encoder 220 and the trained decoder 240 are transferred to the policy-based operation apparatus 200, and when a predetermined downstream operation 201 is input, the policy-based operation apparatus 200 determines optimal skills 150 (150-1, 150-2, and 150-3) using the trained encoder 220 and the trained decoder 240 and performs an operation according to the determined skills 150 (150-1, 150-2, and 150-3).

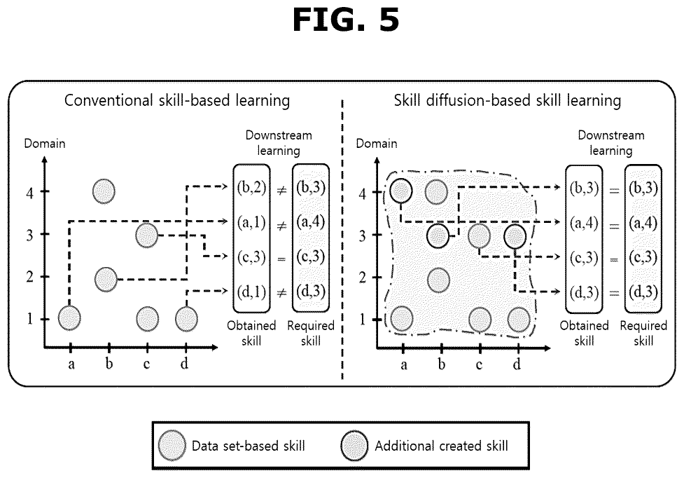

FIG. 5 is a diagram for explaining the effect of skill learning according to skill diffusion according to an embodiment, wherein the left side shows the effect of conventional skill-based learning as a graph, and the right side shows the effect of the above-described policy learning apparatus as a graph. The x-axis of each graph represents different skills (a, b, c, d), the y-axis represents different domains (1, 2, 3, 4), and the circle(s) in the graph means a skill (x-axis) corresponding to a specific domain (y-axis). In addition, coordinates of a circle, for example, (a, 1), mean that the skill a is correspondingly selected with respect to a domain of 1.

As illustrated in the left side of FIG. 5, skills (a, 1), (b, 2), (b, 4), (c, 1), (c, 3), and (d, 1) corresponding to the domain are obtained using the data set, but when the skills required by the downstream operation are given as (b, 3), (a, 4), (c, 3), and (d, 3) differently from the above description because the downstream operation relates to a domain different from the data set used for the learning, the existing learned skill cannot obtain other required skills (b, 3), (a, 4), and (d, 3) except for some skills (c, 3). Therefore, the skill-based learning approach in the related art inevitably has difficulty in selecting an appropriate skill. In particular, since this method consumes more time for skill determination, the performance of the policy-based operation apparatus 200 is inevitably degraded in the case of downstream operations that need to be performed within a limited time. This is likely to occur in environments where various domains exist. This is because different domains can require different skills. However, as shown in the right side of FIG. 5, other skills that are not dependent on the data set through skill diffusing, that is, (a, 4), (b, 3), and (d, 3) When the downstream operation is additionally trained and prepared, the skill required by the downstream operation may be more easily and accurately acquired, and accordingly, the policy-based operation apparatus 200 may operate more stably.

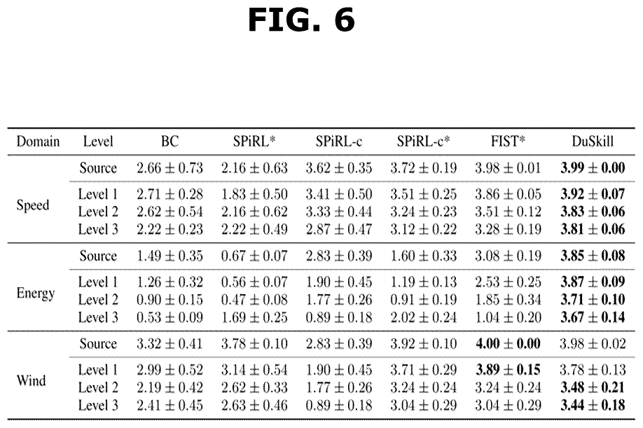

FIG. 6 is a diagram for describing an effect of skill learning according to skill diffusion according to an embodiment of the disclosure, and is a diagram illustrating an adaptation performance when an expert data set is given in a small amount. Here, BC, SPIRL, SpiRL-c, SpiRL-c*, and FIST represent skill learning methods according to the related art, respectively. DuSkill corresponds to the above-described policy learning system 10. An asterisk (*) means that both high-level policies and decoders are fine-tuned. Without an asterisk and DuSkill means that only high-level policies are fine-tuned except for decoders. On the other hand, the domain is given by speed, energy, and wind. In addition, a source is a source domain, which means a domain of a data set used for learning.

As shown in FIG. 6, at the source level, the downstream operation maintains consistency with the source domain, but as the level increases, the domain interval also increases. In this case, most of the conventional skill learning methods show a tendency that the performance thereof is deteriorated. For example, FIST shows performance degradation of about 25%. On the other hand, the above-described policy learning system 10 consistently and firmly maintains its performance at most levels (i.e., sources, levels 1 to 3).

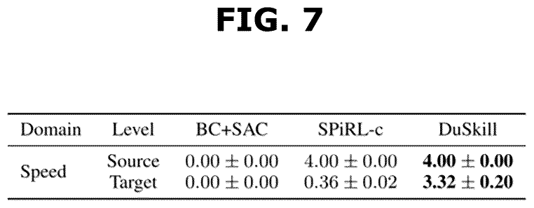

FIG. 7 is a diagram for describing an effect of skill learning according to skill diffusion in the case of online reinforcement learning adaptation, and illustrates adaptation performance in various learning methods by dividing a domain into a source domain and a target domain. Here, the domain is a speed. BC+SAC and SPIRL-c represent a conventional skill learning method, and DuSkill represents a learning method by the policy learning system 10 described above.

As shown in FIG. 7, in the source domain work, there is not a large difference in performance between the SPIRL-c and the policy learning system 10. On the other hand, the policy learning system 10 shows considerably better performance than SPIRL-c for the operation of other domains, that is, the target domain, and specifically shows performance improvement of nearly 90%. This shows that the decoder 140 of the policy learning apparatus 100 has the ability to generate various skills beyond the limitations of a given data set.

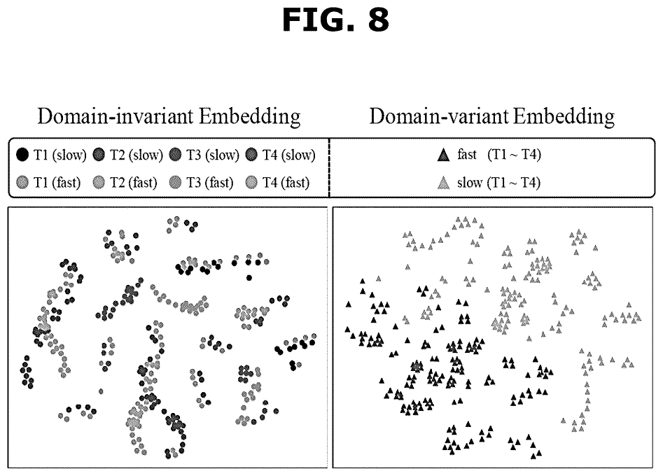

FIG. 8 is a diagram illustrating domain-invariant skill embedding and domain-variant skill embedding according to an embodiment of the disclosure. The left side of FIG. 8 relates to a domain-invariant skill embedding, the right side relates to a domain-variant skill embedding, and in each figure, T1 to T4 refer to labels for sub-tasks. In addition, the visualized domain-invariant skill embedding and the domain-variant skill embedding are those generated under two domains, each representing a different rate (i.e., fast and slow).

Referring to the left part of FIG. 8, in the case of domain-invariant skill embedding, it is confirmed that the same task is paired together and clustered. In other words, in domain-invariant skill embedding, tasks related to each other appear close to each other regardless of the domain. On the other hand, referring to the right side of FIG. 8, it is confirmed that the domain-variant skill embedding is clustered according to the domain. In other words, the embedding corresponding to the fast domain is generally located at the left and the bottom, and the embedding corresponding to the slow domain is generally located at the right and the top. This means that the domain discrimination ability was encapsulated. Therefore, in conclusion, domain-invariant skill embeddings allow skill to be consistently determined and applied despite changes in the domain, and domain-variant skill embeddings allow skill to be determined and applied differently in response to changes in the domain.

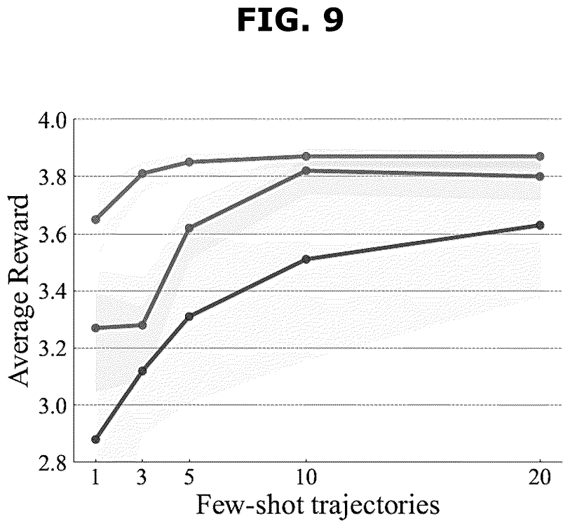

FIG. 9 is a graph diagram for explaining the effect of skill learning according to skill diffusion in the case of few-shot imitation learning, and illustrates a test result in a situation in which the number of few-shot trajectories is set to 1, 3, 5, 10, and 20. In FIG. 9, the y-axis represents the average compensation, and the x-axis represents the number of few-shot trajectories. Each line in the graph corresponds to compensation by the policy learning apparatus 100, compensation by FIST, and compensation by SPIRL-c* from above.

As shown in FIG. 9, the policy learning apparatus 100 shows relatively high robustness with a substantially constant reward despite the increase in the few-shot trajectory. In particular, the average compensation of FIST or SPIRL-c* differs greatly in the case where the value of the few-shot trajectory is 1 and 20, but the average compensation of the policy learning apparatus 100 shows only a relatively small difference.

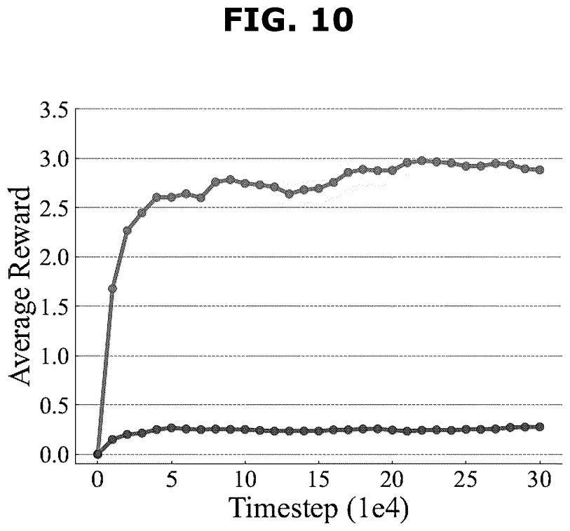

FIG. 10 is a graph diagram for explaining the effect of skill learning according to skill diffusion in the case of online reinforcement learning adaptation. In FIG. 9, a y-axis represents average compensation, and an x-axis represents time. Each line in the graph corresponds to compensation by the policy learning apparatus 100 and compensation by SPIRL-c* from above.

As shown in FIG. 10, in SPIRL-c, the average reward is maintained to be extremely low even with the passage of time, and performance improvement is hardly observed, whereas even in the case of online reinforcement learning, the policy learning apparatus 100 may know that the average reward reaches a higher value more rapidly. In particular, the processing result of the policy learning apparatus 100 shows performance improved by about 89% compared to SPIRL-c.

In summary, it can be seen that the policy learning apparatus 100 and the policy learning system 10 including the same may perform appropriate policy adaptation at higher performance even in a situation where a change in the domain occurs, unlike other conventional technologies.

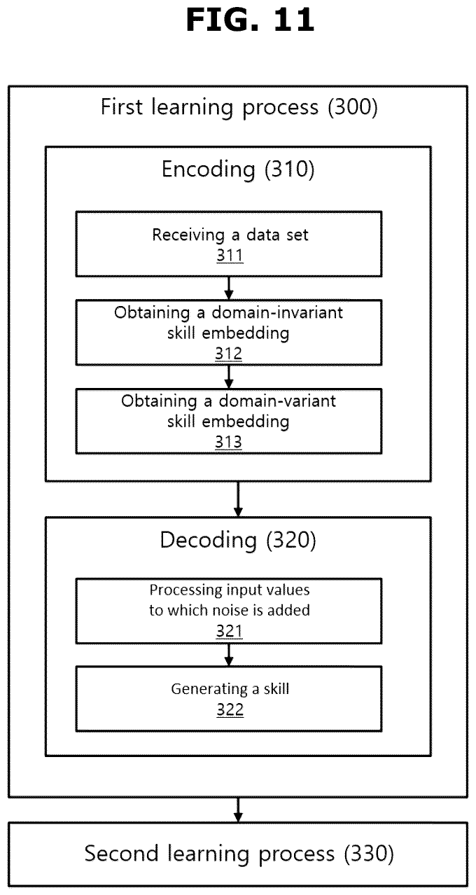

Hereinafter, an embodiment of a policy learning method will be described with reference to FIG. 11.

FIG. 11 is a flowchart of a policy learning method according to an embodiment.

Referring to FIG. 11, in an embodiment, the policy learning method may be performed through a first learning process 300 and a second learning process 330.

The first learning process 300 may be performed through encoding 310 and decoding 320. Here, the encoding 310 and the decoding 320 may be simultaneously performed in all or some of them, or may be sequentially performed at different times.

Encoding 310 may be performed through a process of receiving a data set of a predetermined domain (311), obtaining a domain-invariant skill embedding using the data set (312), and obtaining a domain-variant skill embedding using the domain-invariant skill embedding and a domain parameter of the data set (313). Here, the input data set may include at least one entire sequence, and the entire sequence may be provided by arranging at least one state and at least one action in a predetermined order.

The domain-invariant skill embedding is generated based on at least one of all states in the entire sequence and at least one of all actions in the entire sequence, but may be generated further using a domain-invariant prior according to an embodiment. The domain-invariant prior is a value for information obtained in advance for an environment, a state, or the like, and at least one state may be added as a condition to obtain an appropriate domain-invariant skill embedding.

The domain-variant skill embedding may be obtained by being learned using a domain-invariant skill embedding and a domain parameter as an input. The domain-variant skill embedding may also be acquired by further using the domain-variant prior. The domain-variant prior is provided to provide a prior distribution for domain-variant skill embedding

The decoding 320 may be performed by deriving and obtaining a corresponding skill using a domain-invariant skill embedding and a domain-variant skill embedding, and may be performed using, for example, a noise removal method. According to an embodiment using the noise removal method, the decoding 320 may be performed by obtaining an input value to which noise is added, obtaining a next input value to which noise is added, removing or minimizing noise through iteration of a corresponding process (321), obtaining at least one action based thereon, and obtaining an action sequence through a combination of actions, thereby generating a skill (322). The acquisition of the noise-added input value and the acquisition of the skill may be performed for each of a domain-invariant skill embedding and a domain-variant skill embedding.

When the first learning process 300 ends, the second learning process 330 may be performed. The second learning process 300 may be a process for fine-tuning the encoder, and may be performed, for example, through at least one of decimal shot imitation learning and online reinforcement learning adaptation.

Accordingly, an encoder and a decoder are trained to obtain an appropriate action and a skill including the same despite a change in the domain of the input data set.

At least one of the skill learning method and the downstream policy learning method according to the above-described embodiment may be implemented in the form of a program that may be driven by a computer apparatus. The program may include instructions, libraries, data files and/or data structures alone or in combination, and may be designed and manufactured using machine language code or high-level language code. The program may be specially designed to implement the above-described method, or may be implemented using various functions or definitions known to those skilled in the art in the field of computer software. In addition, here, the computer apparatus may be implemented to include a processor, a memory, or the like that enables a function of a program to be realized, and may further include a communication apparatus as necessary. A program for implementing at least one of the skill learning method and the downstream policy learning method described above may be recorded in a recording medium readable by an apparatus such as a computer. The computer-readable recording medium may include, for example, a semiconductor storage medium such as a ROM, a RAM, an SD card, or a flash memory (e.g., a solid state drive (SSD)), a magnetic disk storage medium such as a hard disk or a floppy disk, an optical storage medium such as a compact disk or a DVD, or a magneto-optical storage medium such as a floptical disk, which is capable of temporarily or non-temporarily storing one or more programs executed according to a call of an apparatus such as a computer.

Although various embodiments of the policy learning apparatus, the downstream policy learning apparatus, the policy learning system, the skill learning method, and the downstream policy learning method have been described above, at least one of the policy learning apparatus, the downstream policy learning apparatus, the policy learning system, the skill learning method, and the downstream policy learning method is not limited to the above-described embodiments. Other various apparatus, systems, or methods that can be implemented by those skilled in the art by modifying and modifying based on the above-described embodiments may also be embodiments of the above-described policy learning apparatus, downstream policy learning apparatus, policy learning system, skill learning method, or downstream policy learning method. For example, even if the described method(s) are performed in a different order from that described, and/or the component(s) of the described system, structure, apparatus, circuit, etc. are combined, connected, or combined in a different form from that described, or are substituted or substituted by another component or equivalent, it may be an embodiment of at least one of the above-described policy learning apparatus, downstream policy learning apparatus, policy learning system, skill learning method, and downstream policy learning method.

Those skilled in the art related to the embodiments of the present invention will understand that modifications can be implemented without departing from the essential characteristics described herein. Therefore, the disclosed methods should be considered in an illustrative rather than a restrictive sense. The scope of the present invention is defined by the claims rather than the detailed description, and all variations within an equivalent scope should be interpreted as being included in the scope of the present invention.

What is claimed is:

1. A policy learning apparatus comprising:
an encoder configured to be trained to obtain a domain-invariant skill embedding based on at least one state and at least one action, and obtain a domain-variant skill embedding based on a domain parameter corresponding to the at least one state and the at least one action and the domain-invariant skill embedding; and
a decoder configured to be trained to obtain a skill as an output value using the domain-invariant skill embedding and the domain-variant skill embedding as inputs.

2. The policy learning apparatus of claim 1,
wherein the encoder obtains the domain-invariant skill embedding by further using a domain-invariant prior generated according to a predetermined state, or obtains the domain-variant skill embedding by further using a domain-variant prior providing a prior distribution for the domain-variant skill embedding.

3. The policy learning apparatus of claim 1,
wherein the decoder obtains an input value to which noise is added by adding noise to at least one action, with respect to at least one of the domain-invariant skill embedding and the domain-variant skill embedding.

4. The policy learning apparatus of claim 3,
wherein the decoder obtains at least one action by repeatedly obtaining a next input a predetermined number of times and removing the noise, and obtains at least one skill through a combination of the obtaining.

5. The policy learning apparatus of claim 1,
wherein the encoder is further trained through at least one of few-shot imitation learning and online reinforcement learning adaptation.

6. A policy learning method comprising:
obtaining, by an encoder, a domain-invariant skill embedding as an output by inputting at least one state and at least one action;
obtaining, by the encoder, a domain-variant skill embedding as an output by inputting a domain parameter corresponding to the at least one state and the at least one action and the domain-constant skill embedding; and
obtaining, by a decoder, a skill as an output by inputting the domain-invariant skill embedding and the domain-variant skill embedding.

7. The policy learning method of claim 6,
wherein the obtaining the domain-invariant skill embedding as an output comprises obtaining the domain-invariant skill embedding by further using a domain-invariant prior generated according to a predetermined state, or wherein the obtaining the domain-variant skill embedding as an output comprises obtaining the domain-variant skill embedding by further using a domain-variant prior providing a prior distribution for the domain-variant skill embedding.

8. The policy learning method of claim 6,
wherein the obtaining, by a decoder, a skill as an output by inputting the domain-invariant skill embedding and the domain-variant skill embedding further comprises obtaining an input value to which noise is added by adding noise to at least one action, with respect to at least one of the domain-invariant skill embedding and the domain-variant skill embedding.

9. The policy learning method of claim 8,
wherein the obtaining, by a decoder, a skill as an output by inputting the domain-invariant skill embedding and the domain-variant skill embedding further comprises obtaining at least one action by repeatedly obtaining a next input a predetermined number of times and removing the noise, and obtaining at least one skill through a combination of the obtaining.

10. The policy learning method of claim 1, further comprising:
further training the encoder through at least one of few-shot imitation learning and online reinforcement learning adaptation.

11. A policy-based operation apparatus comprising:
an encoder pre-trained to obtain a domain-invariant skill embedding based on at least one state and at least one action, and obtain a domain-variant skill embedding based on a domain parameter corresponding to the at least one state and the at least one action and the domain-invariant skill embedding; and
a decoder trained to obtain a skill corresponding to a downstream operation input based on the domain-invariant skill embedding and the domain-variant skill embedding.
